(19) United States
(12) Patent Application Publication
(10) Pub. No.: US 2011/0153327 A1
(43) Pub. Date: Jun. 23, 2011

(54) SYSTEMS AND METHODS FOR IDENTITY MATCHING BASED ON PHONETIC AND EDIT DISTANCE MATCHING

(76) Inventor: Anthony S. Iasso, Haymarket, VA (US)

(21) Appl. No.: 12/918,418

(22) PCT Filed: Feb. 22, 2008
(86) PCT No.: PCT/US2008/054813

§ 371 Date: Feb. 28, 2011

(51) Int. Cl. G10L 15/06

(52) U.S. Cl. 704/243; 704/E15.014

(57) ABSTRACT

According to embodiments of the present disclosure, a matching module is configured to accurately match a probe identity of an entity to a collection of entities. The matching module is configured to match the probe identity of the entity to the collection of entities based on a combination of phonetic matching processes and edit distance processes. The matching module is configured to create phonetic groups for name parts of identities in the collection. The matching module is configured to compare probe name parts of the probe identity to the name parts associated with the phonetic groups.

### FIELD

This invention relates generally to language searching systems and methods.

### BACKGROUND

Security systems implement various processes for identifying and verifying the identity of a person. Typically, security systems also track entities in order to prevent dangerous or suspected dangerous entities from causing mischief. Often, the security systems maintain a list of the entities in order to verify that those who come into contact with the systems are not the suspected dangerous entities. For example, the security systems may maintain watchlists containing the identity of the entities.

In order to determine if an entity is on a watchlist, the identity of the entity is entered into the security system in order to compare this identity with the identity of entities contained in the watchlist. Typically, the identity consists of the entity's name. To compare the entity's name with watchlisted names, the security system executes a matching algorithm to compare the entered name to names of entities contained in the watchlist.

Currently, security systems utilize several different matching algorithms to compare the entity's name to names contained in a watchlist. One type of matching algorithm is a phonetic algorithm. A phonetic algorithm performs matching based on how a name is pronounced. “Soundex” is one type of phonetic algorithm. Soundex performs the matching process by indexing names by sound, as pronounced in English. The goal is for names with the same pronunciation to be encoded to the same representation so that they can be matched despite minor differences in spelling. “Metaphone” and “Double Metaphone” written by Lawrence Philips are other types of phonetic algorithms.

Another algorithm utilized by security systems is edit distance. Instead of utilizing the sound of a name, edit distance algorithms match names based the textual character representations of the names. Edit distance is the number of operations, such as delete or replace, performed on characters in the name, that are required to transform one name into another name. One example algorithm utilized to perform edit distance is the Damerau-Levenshtein distance algorithm.

However, in a typical matching process, the security systems do not always accurately match every name. Phonetic algorithms can miss matches for names that do not originate in the language being utilized. Edit distance algorithms fail to account for different pronunciation of characters. Phonetic algorithms and edit distance algorithms can miss matches if the name is incorrectly entered into the security system. Thus, there is a need in the art for a mechanism to provide accurate and efficient matching systems and methods.

### BRIEF DESCRIPTION OF THE DRAWINGS

The accompanying drawings, which are incorporated in and constitute a part of this specification, illustrate embodiments of the present disclosure and together with the description, serve to explain the embodiments.

FIG. 1 is a diagram illustrating an entity identification and tracking system consistent with embodiments of the present disclosure.

FIG. 2 is a diagram illustrating an exemplary computing system in the entity identification and tracking system consistent with embodiments of the present disclosure.

FIG. 3 is a diagram illustrating an exemplary matching module consistent with embodiments of the present disclosure.

FIG. 4 is a diagram illustrating an exemplary entity matching interface consistent with embodiments of the present disclosure.

FIGS. 5A and 5B are diagrams illustrating exemplary processes for creating phonetic groups consistent with embodiments of the present disclosure.

FIGS. 6A and 6B are diagrams illustrating exemplary processes for name matching consistent with embodiments of the present disclosure.

FIGS. 7A-7E are diagrams illustrating exemplary information consistent with embodiments of the present disclosure.

### DETAILED DESCRIPTION

According to embodiments of the present disclosure, a matching module is configured to accurately match a probe identity of an entity to a collection of entities. The matching module is configured to match the probe identity of the entity to the collection of entities based on a combination of phonetic matching processes and edit distance processes. The matching module is configured to create phonetic groups for name parts of identities in the collection. The matching module is configured to compare probe name parts of the probe identity to the name parts associated with the phonetic groups.

Reference will now be made in detail to the exemplary embodiments of the disclosure, an example of which is illustrated in the accompanying drawings. Wherever possible, the same reference names and numbers will be used throughout the drawings to refer to the same or like parts.

In the following description, reference is made to the accompanying drawings that form a part thereof, and in which is shown by way of illustration specific exemplary embodiments. These embodiments are described in sufficient detail to enable those skilled in the art to practice the embodiments and it is to be understood that other embodiments can be used and that changes can be made without departing from the scope of this disclosure. The following description is, therefore, merely exemplary.

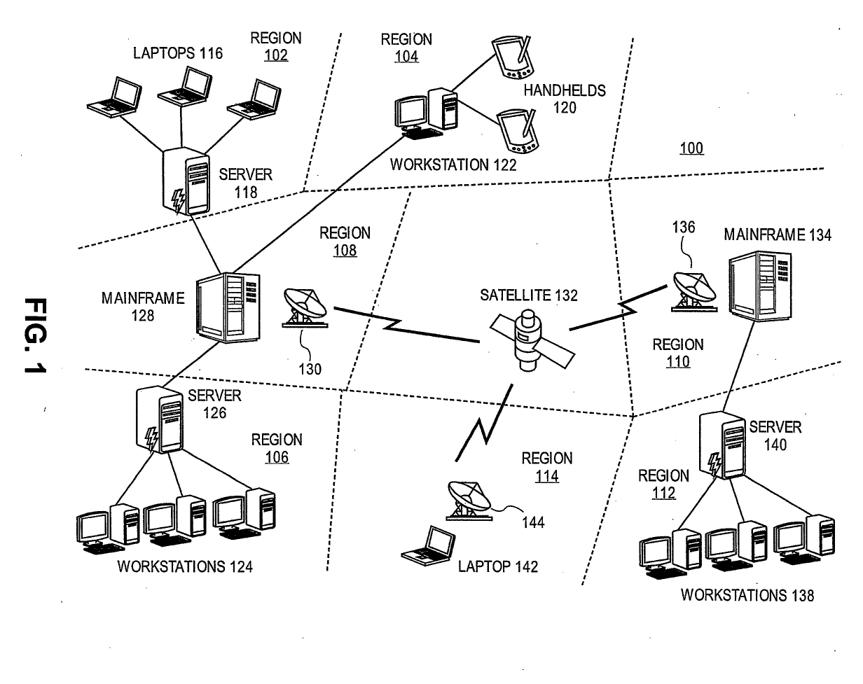

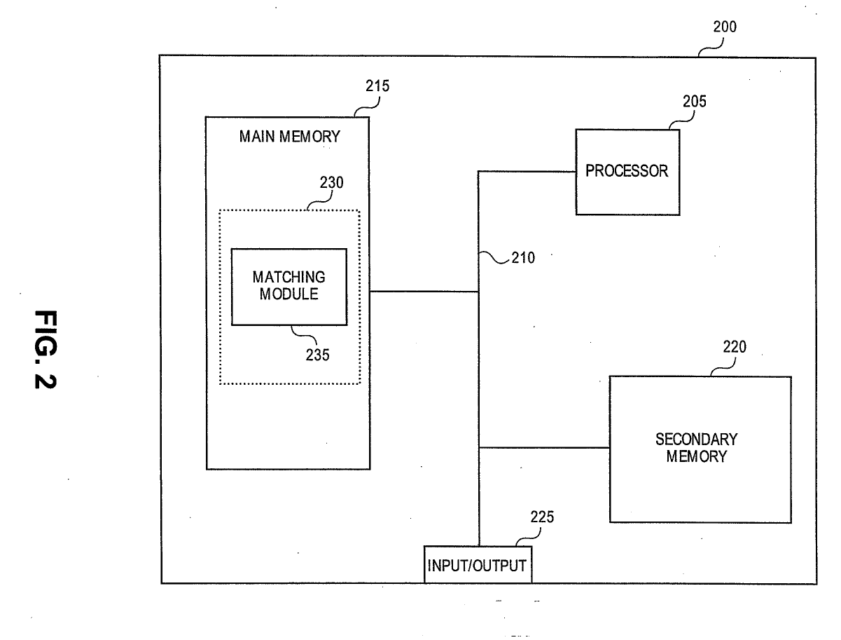

A matching module allows fast, flexible, and accurate processes for matching the identity of an entity to a collection of entities. FIG. 1 is a diagram illustrating an entity identification and tracking system 100 capable of implementing a matching module consistent with embodiments of the disclosure. The system includes multiple computing systems located in various geographic regions. Each computing system in system 100 can implement an instance of the matching module. Each computing system captures the identity of entities and uses the matching module to compare the identity of a collection of entities, such as a watchlist. Each of the computing systems can provide the users of the computing systems with the results of the comparison.

As illustrated in FIG. 1, the computing systems can be located in, for example, seven different geographic regions: Region 102, Region 104, Region 106, Region 108, Region 110, Region 112, and Region 114. The geographic regions can be located at any place in the world. For example, the geographic regions can be located in a single city. Furthermore, the geographic regions can be spread out over the entire globe with multiple regions located in different countries or on different continents. One skilled in the art will realize that the geographic regions and computing systems illustrated in FIG. 1 are exemplary and that system 100 can include any number of computing systems located in any number of geographic regions.

As shown, Region 102 can include several laptop computing systems 116 networked to a server computing system 118. Region 104 can include several handheld computing systems 120 networked to a workstation computing system 122. Region 106 can include several workstation computing systems 124 networked to a server computing system 126. Region 108 can include a mainframe computing system 128 networked to the computing systems in Regions 102, 104, and 106. Region 108 can include a satellite uplink 130 to transmit information to other regions via satellite 132.

Region 110 can include another mainframe computing system 134 networked to the computer systems in Region 112 and can include a satellite uplink 136 to transmit information to other regions, such as Regions 102, 104, 106, and 108 via satellite 132. Region 112 can include several workstation computing systems 138 networked to a server computing system 140. Region 114 can include a laptop computing system 142 and a satellite uplink 144 to communicate to other geographic regions via satellite 132.

The computing systems can communicate with one another via any type of communication channel and protocol. For example, the computing systems in a particular geographic region can be networked in a LAN configuration. Further, all of the computing systems in system 100 can be networked in a WAN configuration. The computing systems can communicate via any type of communication channel such as wired, satellite, cellular, radio frequencies including WiFi (802.11a, b, g, n), or any other current or future wired or wireless protocols.

System 100 allows the capture and matching of the identity of entities. The information allows system 100 to identify possible entities of interest that come into contact with system 100. In order to compare and match the identity of entities to collection of entities, the computing systems of the geographic regions can implement a matching module.

The matching module matches the identity of the entity to the collection of entities. For example, the computing systems can implement an application providing the features and functionality of the matching module. Additionally, the matching module can be configured to function with other security applications in order to identify, classify, and track the entities. For example, the matching module can be configured to function as a feature of a Biometrics Automated Toolset (BAT) as described in U.S. patent application Ser. No. 11/966,333 filed on Dec. 28, 2007, the specification of which is incorporated herein in its entirety by reference.

For example, system 100 can be used in a conflict setting in which the identity of entities can be used to distinguish friend from foe. As such, geographic Regions 102, 104, 106, and 108 can be located in the theater of conflict. Military personnel can desire to identify and track entities in the theater in order to distinguish friend and foe and to identify and track entities as they travel between geographic regions. Accordingly, the personnel in Regions 102, 104, 106, and 108 can use the computing systems with the matching module to match the identity of entities with collections of entities identified as possible threats. The personnel can use the matching module to compare the identity, such as a name, to a collection of entities, such as a watchlist, and determine possible candidate entities that possibly match the received identity. The personnel can share the results of the matching with other computing systems in system 100.

The personnel can also use the matching module to share and retrieve information about entities from other geographic regions. For example, when performing the matching, the computer systems can share collections of entities between the geographic regions. This allows the personnel, for example, to identify entities in real time at virtually any location and thereby identify and prevent foes from traveling region to region and creating mischief. Further, the personnel can use matching module to transmit the results of matching to and from regions outside the theater of conflict such as Regions 110, 112, and 114.

System 100 above illustrates computing systems positioned and communicating in several configurations. One skilled in the art will realize that the configuration of the computing systems in system 100 is exemplary and that the computing systems can be arranged in various configurations according to local capability and need in order to communicate by various procedures.

For example, a single laptop computing system can be located in another geographic region (not shown). As such, data can be moved using removable and recordable media such as a USB drive or a CD-R instead of by direct network link. Additionally, for example, several laptop computing systems can be networked together, with one designated as the local “server.”

As mentioned above, the computer systems of system 100 utilize a matching module to capture, compare and match the identity of entities with a collection of entities. In system 100, the various computing systems can include a computing platform to function as a platform for the matching module. FIG. 2 is a diagram illustrating an exemplary configuration of a computing platform 200, in which the matching module can be implemented. As illustrated, computing platform 200 can include a processor 205, communication bus 210, main memory 215, secondary memory 220, and input/output 225. One skilled in the art will realize that the components of computing platform 200 are exemplary and computing platform 200 can include additional hardware.

As shown in FIG. 2, computing platform 200 can include one or more processors, such as processor 205 that provide an execution platform for embodiments of an application 230 and a matching module 235. Processor 205 can be, for example, a central processing unit (CPU), a micro-controller unit (MCU), digital signal processor (DSP), or the like. Commands and data from processor 205 are communicated over a communication bus 210. Computing platform 200 also includes a main memory 215, such as a Random Access Memory (RAM), where application 230 including matching module 235 can be executed during runtime, and a secondary memory 220. Additionally, an operating system (OS) such as those from MICROSOFT® can be executed on main memory 215 during runtime.

Secondary memory 220 can include, for example, a hard disk drive (not shown) and/or a removable storage drive (not shown), representing a floppy diskette drive, a magnetic tape drive, a compact disk drive, etc., where a copy, whole or in part, of a computer program embodiment for application 230 and matching module 235 can be stored. For example, application 230 and matching module 235 can be stored in secondary memory 220 and, during runtime, application 230 and matching module 235, whole or in part, can be loaded into main memory 215.

Input/output 225 provides an interface where data, such as identity of entities, can be transferred to and from computing platform 200. For example, input/output 225 can include a keyboard, a mouse, a display, a network interface, sound device and the like.

Application 230 can be any type of application capable of functioning with matching module 235 to implement the functionality of matching module 235. For example, application 230 can be a standalone application designed to solely perform the functionality of matching module 235. Additionally, application 230 can be a security application, such as BAT, that provides additional functionality in combination with the functionality of matching module 235.

Application 230 and matching module 235 can be written in program code and executed by computing platform 200. Application 230 and matching module 235 can be implemented in computer languages such as PASCAL, C, C++, VISUAL BASIC JAVA, HTML, XML and the like. One skilled in the art will realize that the components, functions, and methods described above and below can be implemented in any computer language and any application.

Application 230 and matching module 235 can be embodied in secondary memory 220 and/or main memory 215 (as illustrated) as instructions for causing computing platform 200 to perform the instructions. Secondary memory 220 and main memory 215 can include computer readable signals, in compressed or uncompressed form. Exemplary computer readable signals, whether modulated using a carrier or not, are signals that a computing system can be configured to access, including signals downloaded through the Internet or other networks. Concrete examples of the foregoing include distribution of executable software programs of the computer program on a CD-ROM or via Internet download. In a sense, the Internet itself, as an abstract entity, is a computer readable medium. The same is true of computer networks in general.

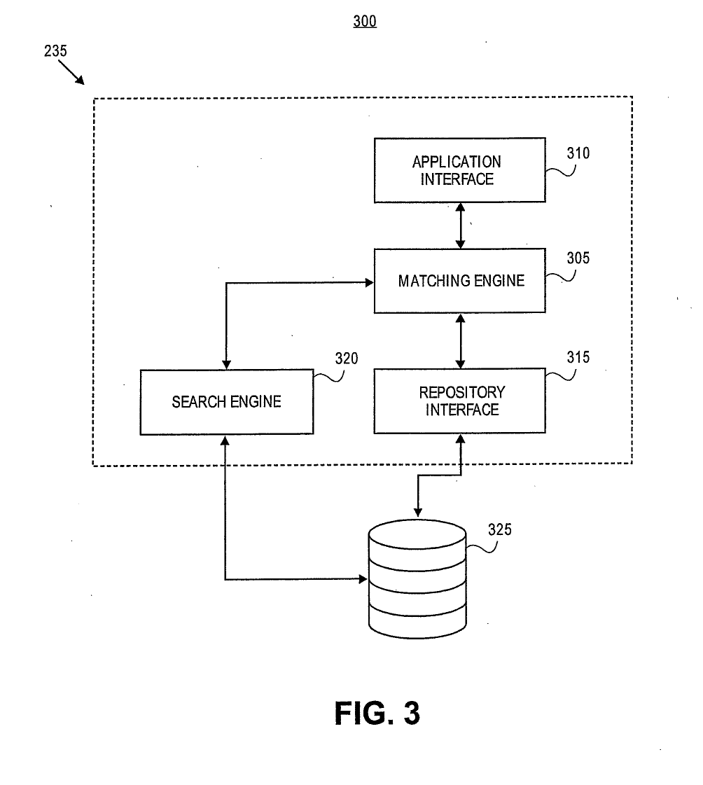

Matching module 235 is configured to receive an identity of an entity and match this identity with a collection of entities. For example, matching module 235 can be configured to receive a name of an entity and match this name with a collection of entity names, such as a watchlist. FIG. 3 depicts a more detailed block diagram 300 of matching module 235 in accordance with a further exemplary embodiment. It should be readily apparent to those of ordinary skill in the art that the diagram depicted in FIG. 3 represents a generalized schematic illustration and that other components may be added or existing components may be removed or modified.

As shown in FIG. 3, matching module 235 can include a matching engine 305, an application interface 310, a repository interface 315, and a search engine 320. Modules 305-320 of matching module can be implemented as software components, hardware components or combinations thereof. More particularly, modules 305-320 can be implemented using conventional programming languages (e.g., Pascal, FORTRAN, etc.), objected oriented programming languages (e.g., C++), Java, PHP, Perl, XML or other similar languages. Modules 305-320 can also be implemented as hardware components such as an application specific integrated circuit, a programmable read-only memory, an EEPROM, a microcontroller, a microprocessor or other similar computing platform.

Matching module 235 can be coupled to a repository 325. Repository 325 can be implemented in any structure such as a database. For example, repository 325 can be implemented utilizing any type of conventional database architecture using open source technologies, proprietary technologies, or combinations thereof. Repository 325 can be configured to store collections of entities, such as watchlist, that can be utilized by matching module 225. Matching engine 305 can be configured to communicate with repository 325 via a repository interface 315. Repository 325 can be a part of matching module 235 or separate from matching module 235.

Matching engine 305 can be configured to manage modules 310-320 to provide the functionality of matching module 235 as previously described and further described herein below. In particular, matching engine 305 is configured to receive an identity of an entity. In matching module 235, an entity can refer to a person who is in contact with system 100. Matching module 235 tracks an entity by associating one or more identities with the entity. For example, a person in contact with system 100 can have one or more names associated with them. An exemplary entity can have a primary identity of “Alexander Jonathan Harrington” and an alias identity of “Johnny James Bennett.”

Matching module 235 can also associate a global ID with each entity. The global ID uniquely identifies an entity in system 100. The global ID can consist of a string of characters that are unique to each entity. Since both the primary and alias identity refer to the same entity, matching module 235 assign a single global ID to the entity in order to uniquely identify the entity. For example, matching module 235 can assign the entity, with a primary identity of “Alexander Jonathan Harrington” and an alias identity of “Johnny James Bennett”, a global ID of “A0DE25CD-8898-428E-A67C-E204A657FF1C”.

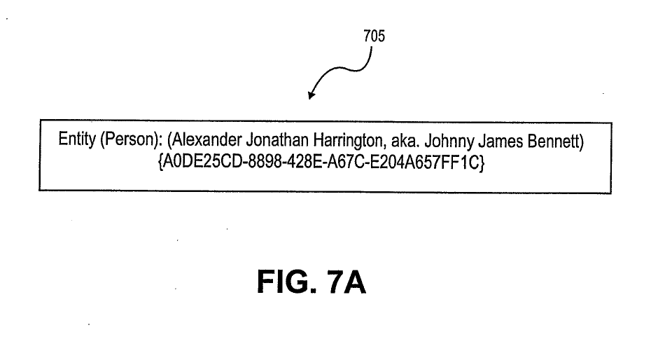

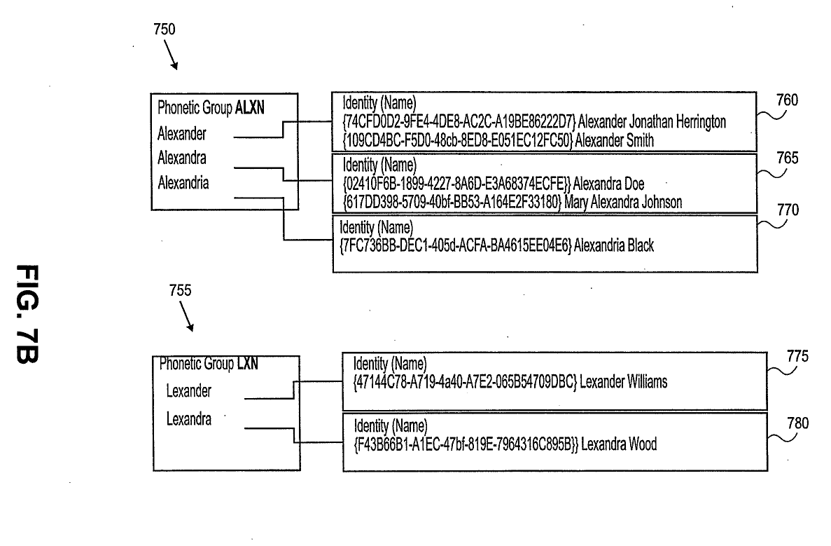

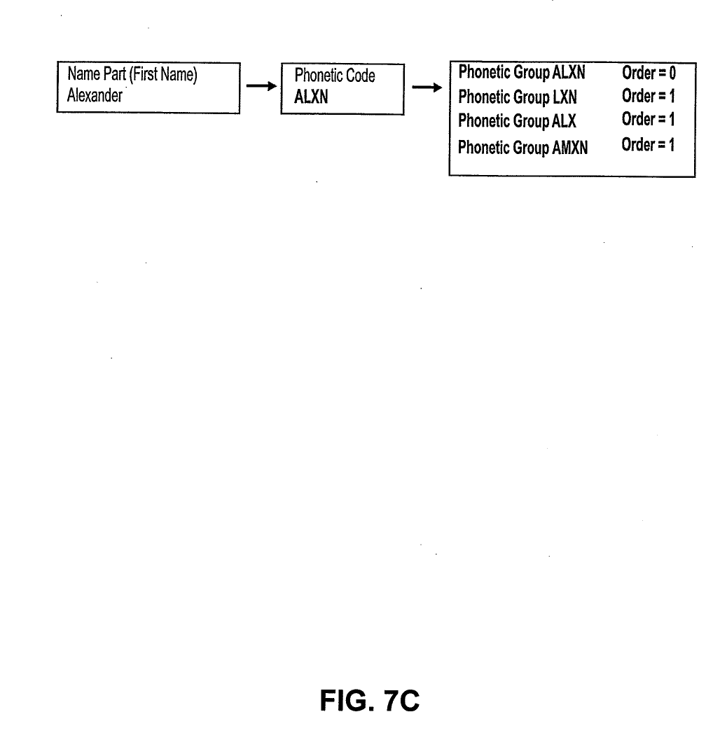

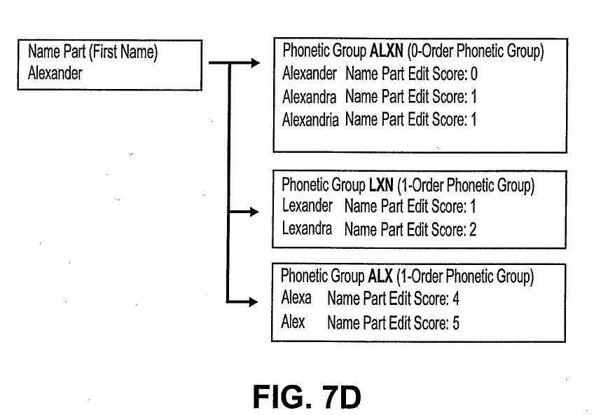

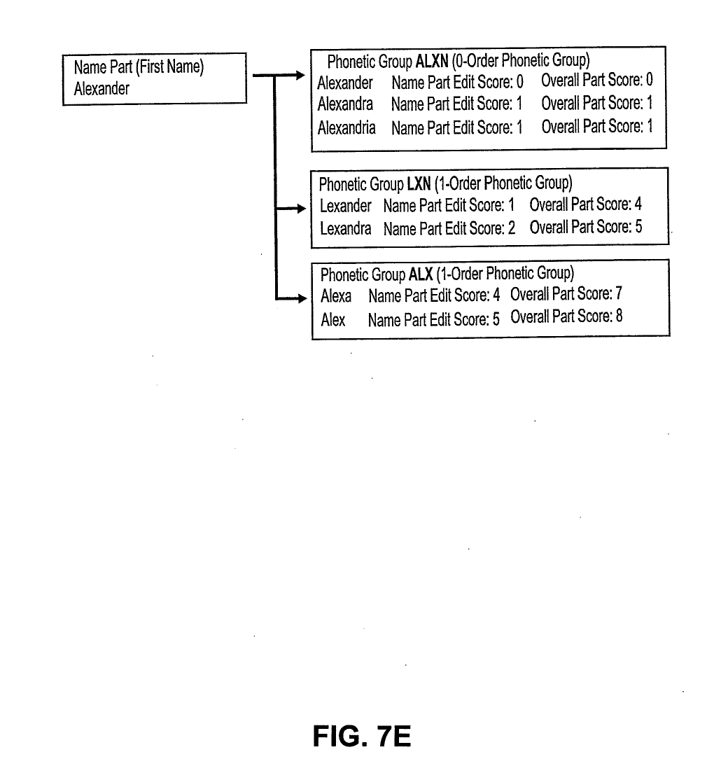

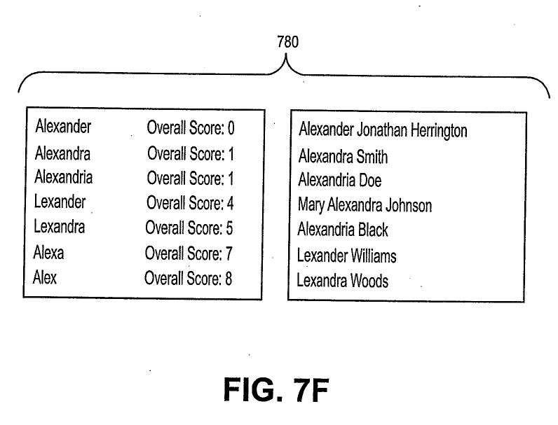

Typically, an entity's identity includes one or more name parts. For example, the identity “Alexander Jonathan Harrington” consists of three name parts: a first name, middle name, and last name. Matching engine 305 can store a complete record of the entity including all identities and global ID in repository 335. FIG. 7A illustrates an exemplary record 705 that can be utilized by matching engine 305 to store the identity and global ID of an entity.

Matching engine 305 is configured to receive the identity of the entity to be matched. Matching engine 305 can label the received identity as the probe identity. The probe identity can consist of one or more probe name parts. For example, the probe identity “Alexander Jonathan Harrington” consists of three probe name parts “Alexander”, “Jonathan”, and “Harrington.”

Matching module 325 is configured to maintain collections of entities in repository 325. Matching engine 305 is configured to match one or more of the probe name parts to the collection of entities in repository 325. Matching engine 305 is configured to match probe name parts with a collection of entities utilizing a combination of both phonetic matching and edit distance matching.

Phonetic matching attempts to match name parts with the name parts of entities in a collection based the names sounding similar. Phonetic matching determines matching name parts by transforming the name parts into a phonetic code. The code represents a shorter version of the name parts in order to map portions of the name parts that sound similar to the same code. Similar sounding characters and groups of characters are mapped to the same phonetic code. Repeated and irrelevant characters are dropped. For example, the characters “m” and “n” are pronounced similarly and are mapped to the same code.

Double metaphone is one algorithm utilized by matching engine 305 to match name parts using phonetic matching. Double metaphone transforms the name parts into a code based portion of the name parts that sound the same. The names can be transformed utilized any well-known metaphone, double metaphone, soundex or other phonetic conversion codex. For example, the name part “Alexander” transforms into the phonetic code “ALXN”. Once a name part is converted into the phonetic code, the phonetic code is compared to the phonetic codes of other name parts. The name parts match if the phonetic codes are the same.

Double metaphone additionally generate two codes for a name part: a primary code and a secondary code. The primary code represents the common pronunciations of the name part and the secondary code represents pronunciation variation of the name part, such as regional or language specific pronunciation. Two name parts are determined to match if either the primary or secondary codes match.

Edit distance compares two strings based on the number of edit operations performed on the characters of the strings required to transform one string into another string. A string can be a sequence of characters that make up an identity or name part. The edit operations can include character operations such as substitute, delete, add, and transpose. For example, the strings “Smith” and “Smoot” are an edit distance of 3 apart: transpose “t” and “h”, substitute “i” with “o”, and substitute “h” with “o”.

Matching engine 305 utilize both phonetic matching, for example double metaphone, and edit distance matching to compare one or more probe name parts of the probe identity to a collection of entities, such as a watchlist. To achieve this, matching engine 305 is configured to organize the name parts of identities in the collections of entities into phonetic groups.

To organize the name parts into phonetic groups, matching engine 305 determines the phonetic codes, for example the double metaphone codes, for the name parts of each identity contained in the collection of entities. Matching engine 305 creates a phonetic group for each unique determined phonetic code. Matching engine 305 then associates each identity in the collection of entities with the appropriate phonetic group. As such, each phonetic group contains the name parts that map to that particular phonetic code and references the associated identity. Matching engine 305 can store the determined phonetic groups associated with the collections in repository 325.

FIG. 7B illustrates an exemplary phonetic group consistent with embodiments of the present disclosure. As illustrated, a phonetic group 750 is associated with the phonetic code “ALXN” and a phonetic group 755 is associated with the phonetic code “LXN”. Identity 760, 765, and 770 are associated with phonetic group 705 because each identity 760, 765, and 770 has at least one name part that transforms into the phonetic code “ALXN.” Likewise, identity 775 and 780 are associated with phonetic group 755 because each identity 775 and 780 has at least one name part that transforms into the phonetic code “LXN.”

Matching engine 305 is configured to compare the probe name parts to the phonetic groups to determine matches from the collection of entities. To achieve this, matching engine 305 is configured to first select phonetic groups to match with the probe name parts. Matching engine 305 is configured to select the phonetic groups based on a group order. Group order is the edit distance of the phonetic code of the probe name part and the phonetic code of a particular phonetic group. In order to determine the available groups to determine group order, matching engine 305 can utilize search engine 320.

Matching engine 305 can be configured to utilize any well-known edit distance algorithm to calculate the group order. FIG. 7C is an exemplary diagram illustrating the group orders for the name part “Alexander” when compared to phonetic groups with the phonetic codes “ALXN,” “LXN,” “ALX,” and “AMXN.”

When performing matching, matching engine 305 can be configured to utilize all phonetic groups in stored in repository 325. Likewise, matching engine 305 can be configured to utilize only groups that have a group order equal to or less than a maximum group order. The maximum group order can be received with the request for match. Additionally, the maximum group order can be preset in matching engine 305. Likewise, the maximum group order can be calculated during the matching process as discussed below.

After phonetic groups to be matched are determined, matching engine 305 can retrieve the name parts associated with the phonetic groups from repository 325. Matching engine 305 can retrieve the name parts utilizing repository interface 315.

After the name parts associated with the phonetic groups are retrieved, matching engine 305 is configured to compare the probe name part to the name parts of the retrieved phonetic groups. For each name part in the phonetic groups, matching engine 305 can determine a name part edit score. The name part edit score is the edit distance between the probe name part and a particular name part in a phonetic group.

Matching engine 305 can be configured to utilize any well-known edit distance algorithm to calculate the name part edit score. FIG. 7D is an exemplary diagram illustrating the name part edit scores for the name part “Alexander” when compared to name parts in phonetic groups with the phonetic codes “ALXN,” “LXN,” “ALX,” and “AMXN.”

Once the name part edit scores have been determined, matching engine 305 is configured to calculate an overall part score. The overall part score represents a mathematical combination of: group order and the name part edit score. In other words, the overall part score represents the degree two names match phonetically and editorially. The lowest overall part score can represent the best match. For example, the overall part score can be give by the equation:

Overall part score=(group order*constant)+(name part edit score) (1)

where the constant is any constant number to weight the significance of the group order.

FIG. 7E is an exemplary diagram illustrating overall part scores for the name “Alexander” as shown in FIGS. 7C and 7D. The equation utilized to calculate the overall part score in FIG. 7E is given by

Overall part score=(group order*3)+(name part edit score)

Matching engine 305 can be configured to determine an overall part score for each name part in the retrieved phonetic groups. Likewise, matching engine 305 can limit the part name considered based on a maximum name part edit score. Matching engine 305 can be configured to calculate overall part scores for name parts of the retrieved phonetic groups that are equal to or less than the maximum name part edit score. The maximum name part edit score can be received with the request for match. Additionally, the maximum name part edit score can be preset in matching engine 305.

By matching based on the phonetic and edit distance matching, matching module 235 can compare a received name to names in different phonetic groups. As such, matching module 235 provides a greater degree of accuracy than phonetic matching or edit distance matching alone. Matching module 235 also allows flexibility when matching a name part to a collection of entities by allowing the matching parameters to be altered.

One skilled in the art will realize that equations above are exemplary and that equation (1) can be modified. Matching module 235 can be configured with different mathematical combinations of group order and name part edit score. Equation 1 can be modified to place different emphasis on group order or name part edit score.

Once the overall part score is determined, matching engine 305 can generate a list of candidates. The candidates can include the identities associated with name parts for which an overall part score is determined. Additionally, the candidates can be limited to identities associated with name parts that are within a maximum overall part score.

The candidates list can include the identity of the entities, the global ID of the entities, and the overall part score. Matching engine 305 can retrieve the identity of the entities and the global ID of the entities from repository 325 utilizing repository interface 315. FIG. 7F illustrates an exemplary candidates list 780 for the name part “Alexander” shown in FIGS. 7C, 7D, and 7E.

Typically, an entity's identity includes one or more name parts. For example, the identity “Alexander Jonathan Harrington” consists of three name parts: a first name, middle name, and last name. Matching engine 305 can be configured to generate phonetic groups for all the name parts of identities in the collection. For example, matching engine 305 can generate phonetic groups for first names, phonetic groups for middle names, and phonetic groups for last names. One skilled in the art will realize that different name parts of identities can also be mapped to the same set of phonetic groups, and that the determination of which name part of the candidate identity matched can be made by examining the name parts of the candidate identity.

As such, when matching module 235 receives a probe identity, matching engine 305 can match all name parts of the name (e.g. first name, middle name, last name). For example, if matching module 235 receives the probe identity “Alexander Jonathan Harrington”, matching engine 305 can perform the matching process on all name parts “Alexander”, “Jonathan”, and “Harrington”.

Matching engine 305 can generate the candidates list to include the identities that match, individually, the name parts of the probe identity. For example, matching engine 305 can generate a candidate lists for each name part of the probe identity. Then, matching engine 305 can combine the candidates lists and include all identities that match any name part.

Additionally, matching engine 305 can calculate an overall identity score for the identities from the phonetic groups. To calculate the overall identity score, matching engine 305 can combine the overall part scores for each name part of the identity. For example, matching module 235 can calculate the overall identity score by adding the overall part score for each name part.

One skilled in the art will realize that overall identity score calculation above is exemplary and that it can be modified. Matching engine 305 can be configured with different mathematical combinations of the overall part score for the name parts. For example, overall identity score can be calculated to place different emphasis on the location of the name part in the identity (e.g. greater emphasis on last name). Likewise, the overall identity score can be calculated to place different weights on transposition of name parts or the absence of name parts in either the probe identity or the identity of the entity in the repository.

Alternatively, matching engine 305 can generate the candidates list to only include the identities that match all the parts of the probe identity. In order to determine the candidates for the probe identity, matching engine 305 can generate a candidate lists for each name part of the probe identity. Then, matching engine 305 can compare the candidate lists and determine which candidates are the same. The candidates list can include the candidates that are the same. Matching engine 305 can determine the overall identity score for the candidates that are the same.

For example, matching engine 305 can perform a matching process on the last name of a probe identity. Once the candidates for the last name are determined, matching engine 305 can perform a matching process on the first name of the entity. Once the candidates for the first name are determined, matching module 235 can compare the candidates for the last name and the candidates for the first name to determine which candidates are the same. The final candidates list can include the candidates that are the same. Then, matching engine 305 can determine the overall identity score for the candidate that are the same by adding the overall part score for the last name and the overall part score for the first name.

To perform the matching process, matching engine 305 receives an identity of an entity to be compared to the collection of entities. Matching engine 305 can be configured to receive the identity from via an interface generated by application interface 310. Likewise, matching engine 305 can be configured to receive the name from another application such as BAT via application interface 310.

In order to allow a user to interact with matching module 235, matching engine 305 can be coupled to application interface 310. Application interface 310 can be configured to generate user interfaces for receiving identities from a user, for receiving parameters of the matching process, and for providing the candidates list to the user. Application interface 310 can be configured to generate user interfaces including widgets, text fields, and the like that allow a user to interact with matching engine 305 to perform the processes associated with a matching.

If matching module 235 is implemented in a stand alone application, application interface 310 can be configured to generate the user interfaces on execution of the stand alone application. If matching module 235 is implemented in another security application such as BAT, application interface 310 can be configured to generate the user interfaces on initiation of a request from the security application. The security application can generate the request based on selection of a widget in the security application.

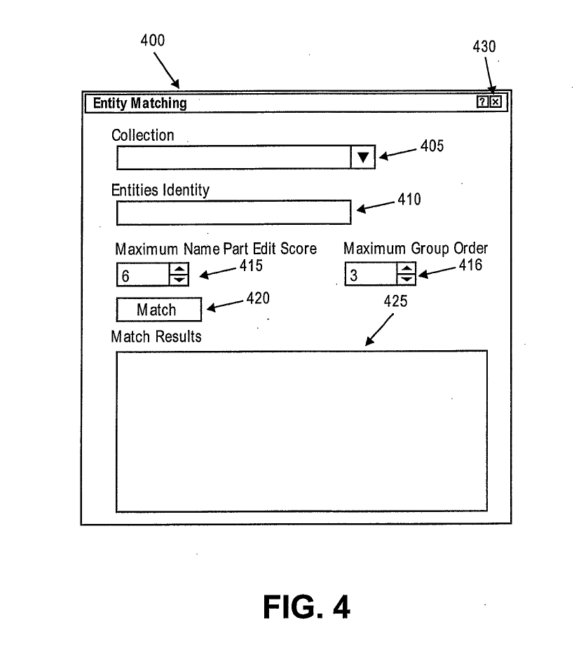

FIG. 4 is a generalized diagram illustrating an entity matching user interface 400 consistent with embodiments of the disclosure. It should be readily apparent to those of ordinary skill in the art that the diagram depicted in FIG. 4 represents a generalized schematic illustration and that other components may be added or existing components may be removed or modified.

As illustrated in FIG. 4, interface 400 can include a collection field 405, an identity information field 410, a maximum name part edit score field 415, a maximum group order field 416, a match button 420, and results field 425. Interface 400 can also include a close button 430. A user can utilize close button 430 to close interface 400.

Collection field 405 can be configured to allow the user to select one or more collections on which to perform the matching process. Collection field 405 can be configured to be interactive to allow the user to select the one or more collections. When a user selects field 405, matching engine 305 can utilize search engine 320 to search for available collections. When search engine 320 returns the available collections, matching engine 305 can transfer the available collections to application interface 310. Application interface 310 can provide the available collections to the user for selection in the matching process.

Identity information field 410 can be configured to receive information about the probe identity of the entity on which to perform the matching process. A user can enter the probe identity in identity information field 410. Maximum name part edit score field 415 can be configured to receive a maximum name part edit score for matching engine 305 to utilize during the matching process. A user can enter the maximum name part edit score in maximum name part edit score field 415.

Maximum group order field 416 can be configured to receive a maximum group order for matching engine 305 to utilize during the matching process. A user can enter the maximum group order in maximum group order field 416.

After all the information is entered, a user can select match button 420 to initiate the matching process. When selected, application interface 310 can pass the selected collections, probe identity, the maximum name part edit score, and the maximum group order to matching engine 305. Matching module 235 can perform the matching process as described above.

To perform the matching process, matching engine 305 can retrieve the phonetic groups and the name parts associated therewith of the selected collections from repository 325 via repository interface 315. Matching engine 305 can then perform the process based on the provided probe identity, the maximum name part edit score, and the maximum group order. Matching engine 305 can perform the matching process and provide the results to application interface 310.

After matching engine 305 has performed the matching process, results field 425 can be configured to display a list of candidates. The results can include a list of information as illustrated in FIG. 7E. Application interface 310 can populate results field 425 with the list.

Results field 425 can also be configured to be interactive. A user can highlight one of the candidates displayed in results field 425. In response, matching engine 305 can retrieve details about the highlighted entity from repository 325 and provide the details to application interface 310. Application interface 310 can generate an interface to display the details and provide the interface to the user.

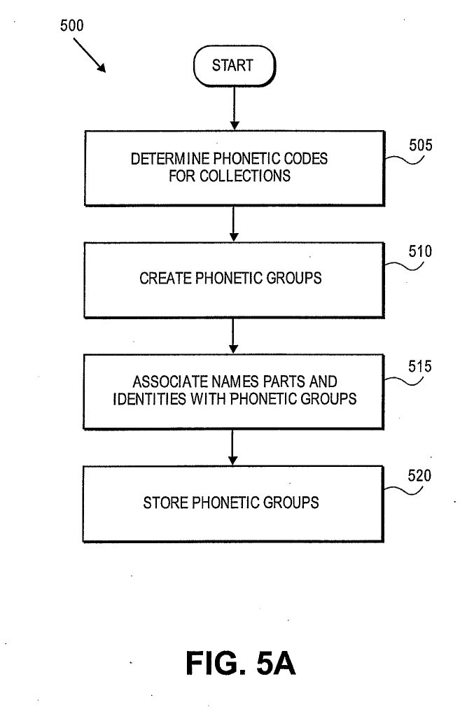

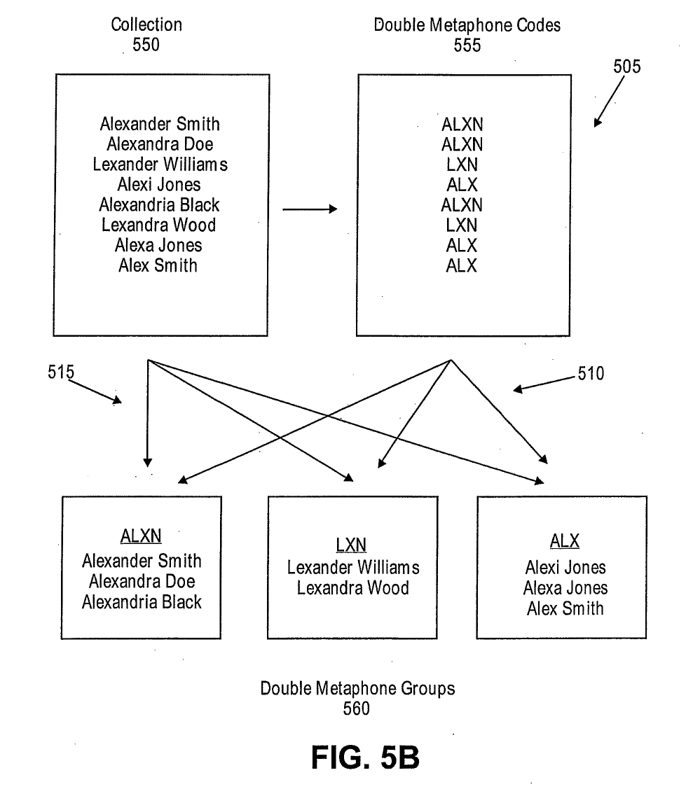

FIGS. 5A and 5B are flow diagrams illustrating a process 500 for generating phonetic groups consistent with embodiments of the present disclosure. The processes can be performed by computing systems in system 100 implementing an application including a matching module as described above in FIGS. 1 through 4. It should be readily apparent to those of ordinary skill in the art that the diagrams depicted in FIGS. 5A and 5B represent generalized illustrations and that other steps may be added or existing steps can be removed or modified.

Process 500 begins with matching module 235 determining the phonetic codes for name parts of identities contained in all collections, in stage 505. Then, matching module 235 creates phonetic groups for each unique phonetic codes determined for the names parts in the collections, in stage 510. Next, matching module 235 associates the name parts and identities of the entities with the corresponding phonetic groups, in stage 515. Then, matching module 235 stores the phonetic groups in repository 325 associated with the corresponding collection, in stage 520.

FIG. 5B illustrates an exemplary generation of the phonetic groups utilizing double metaphone for the first name of a collection of identities. As illustrated, the collection of entities 550 includes a list of identities. In stage 505, matching module 235 determines the double metaphone codes 555 for a name part in collection 550. Then, in stage 510, matching module 235 creates double metaphone groups 560 for each distinct metaphone code 555. Next, in stage 515, matching module 235 associates the identities of collection 550 with the appropriate metaphone group 560.

It should be readily apparent to those of ordinary skill in the art that collection 550 can include additional identities. It should be readily apparent to those of ordinary skill in the art that matching module 235 can also create phonetic groups for the last names in collection 550.

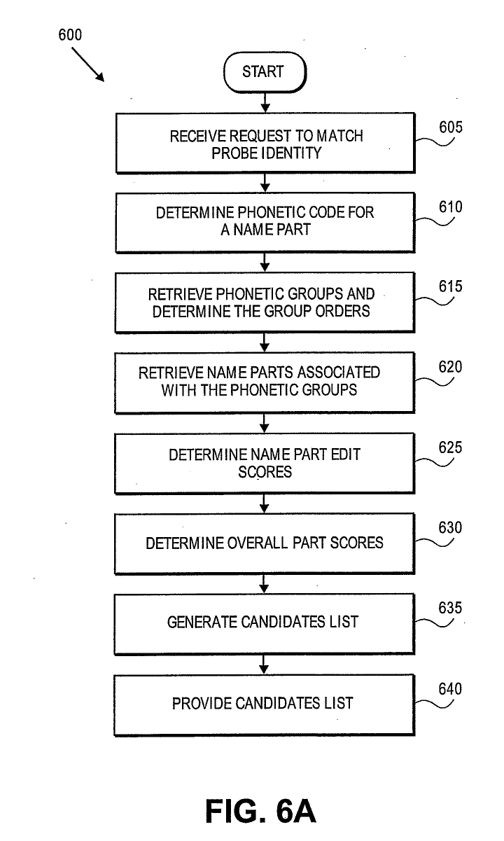

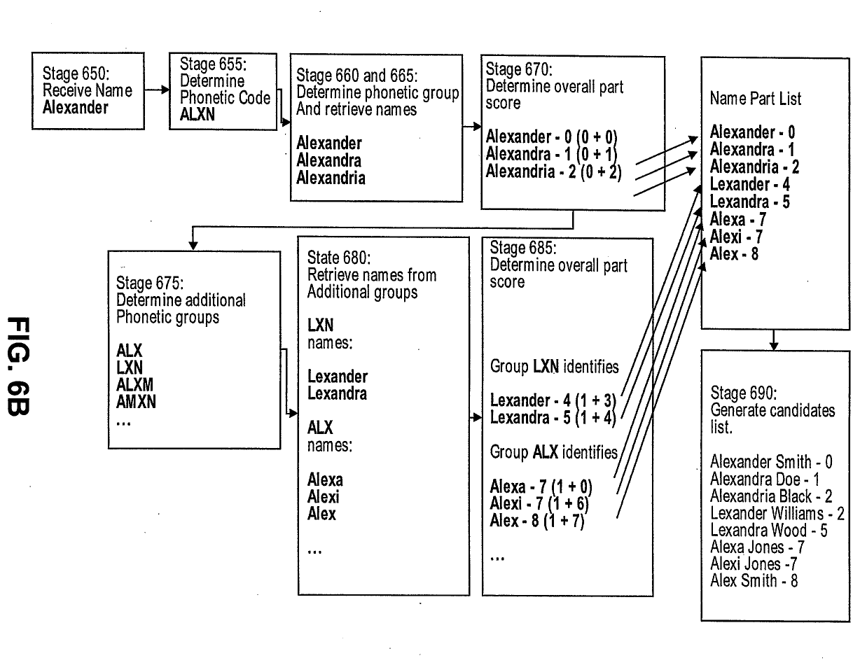

FIGS. 6A and 6B are flow diagrams illustrating a process 600 for matching identities consistent with embodiments of the present disclosure. The processes can be performed by computing systems in system 100 implementing an application including a matching module as described above in FIGS. 1 through 4. It should be readily apparent to those of ordinary skill in the art that the diagrams depicted in FIGS. 6A and 6B represent generalized illustrations and that other steps may be added or existing steps can be removed or modified.

Once the phonetic groups have been created, matching module 235 can begin receiving identities for matching as illustrated in FIG. 6B. Process 600 begins with matching module 235 receiving a request to match a probe identity, in stage 605. The request includes the identity of the entity to be matched. Likewise, the request can also include the collection for matching, a maximum name part edit score, and a maximum group order.

Matching module 235 then determines the phonetic code for a name part of the probe identity, in stage 610. For example, matching module 235 can determine the double metaphone code for the name part.

Next, matching module 235 retrieves the phonetic groups and determines the group orders for the phonetic groups, in stage 615. After determining group orders, matching module 235 retrieves name parts associated with the phonetic group, in stage 620. Matching module 235 can retrieve name parts associated will all the phonetic groups. Likewise, matching module 235 can retrieve the name parts of phonetic groups that are within a maximum group order.

Then, matching module 235 determines the name part edit score for the retrieved names, in stage 625. After determining the name part edit score, matching module 235 can determine the overall part score for the retrieved name parts, in stage 630. For example, matching module 235 can determine the overall part score utilizing equation (1). Matching module 235 can determine the overall part score for all the name parts associated will the phonetic groups. Alternatively, matching module 235 can determine the overall part score for name parts that are within a maximum name part edit score.

Then, matching module 235 generates a candidates list of the identities associated with the name parts for which an overall part score has been calculated, in stage 635. The list can include the identities associated with all the name parts from the phonetic groups. Alternatively, the list can include identities associated with name parts that are within a maximum overall part score.

The list can also include the overall part score for each name. Matching module 235 can order the list of candidates in any order. For example, matching module 235 can order the list of candidates in ascending order based on overall part score.

Then, matching module 235 provides the candidates list to the originator of the request. For example, the list can be provided in an interface as described above.

While FIG. 6A illustrates matching based on one name part of the identity, it should be readily apparent to those of ordinary skill in the art that matching module 235 can perform matching based on complete identity (e.g. a separate matching for each name part) as described above. As such, matching module 235 can generate a candidates list including matches for the complete identity. Additionally, matching module 235 can determine an overall identity score for the complete identity.

FIG. 6B illustrates an exemplary process of matching the name part “Alexander” to the collection illustrated in FIG. 5B. As illustrated, process 600 begins with matching module 235 receiving a request to match the probe name part “Alexander” to collection 550, in stage 650.

Matching module 235 then determines the double metaphone code for the “Alexander”, in stage 655. For example, matching module 235 can determine the double metaphone code for the received name to be “ALXN”.

Next, matching module 235 retrieves the double metaphone group, “ALXN”, that matches the “ALXN” code for the probe name part, in stage 660. After determining the double metaphone group, matching module 235 retrieves all the name parts associated with the “ALXN” group, in stage 665.

Then, matching module 235 determines the group order for the “ALXN” group, the name part edit score for all the name parts in the group, and the overall part score for all the name parts, in stage 670. Matching module 235 can determine the overall part score utilizing equation (1).

For example, matching module 235 can determine the overall part score for “Alexandria” to be 2. That is, the group order of the double metaphone group is 0 (the edit distance between the metaphone code “ALXN” for the probe name part and the metaphone code “ALXN” of the metaphone group is 0). The name part edit score between “Alexander” and “Alexandria” is 2. As such, utilizing equation 1, the overall part score is 2 (0*3+2=2).

Next, matching module 235 retrieves additional double metaphone groups to consider, in stage 670. For example, matching module 235 can retrieve the additional double metaphone groups that are with a determined group order of the phonetic code for the probe name part. For example, matching engine 305 can determine a group order to be 2. As such, matching module 235 selects additional metaphone groups that are 2 edits of “ALXN” (e.g. 1 edit: “ALXN” delete “N”=“ALX”).

After determining the additional phonetic group, matching module 235 retrieves all the name parts associated with the additional double metaphone groups, in stage 680. Then, matching module 235 determines the overall part score for all the names in the additional double metaphone group, in stage 685. For example, matching module 235 can determine the overall part score by determining the group order and name part edit distance and utilizing equation (1).

Then, matching module 235 creates a candidates list including all the identities from the double metaphone group and the additional double metaphone groups, in stage 695. The list can include all the identities associated with name parts from the phonetic group and the additional phonetic groups. The list can also include the overall part score for each name. Matching module 235 can order the list of candidates in any order. For example, matching module 235 can order the list of candidates in ascending order based on overall part score. Additionally, matching module 235 can include the complete identity (e.g. first name and last name) in the candidates list.

While FIG. 6B illustrates receiving only a first name, it should be readily apparent to those of ordinary skill in the art that matching module 235 can receive a complete identity (e.g. first name, last name) and perform a matching on complete identity (e.g. a separate matching for the first name and a separate matching for the last name). As such, matching module 235 can generate a candidates list including matches for the complete identity. Additionally, matching module 235 can determine an overall identity score for the complete identity.

While the entity matching methods and process have been described above in reference to a security setting and application, one of ordinary skill in the art will realize that the entity matching methods and process can be utilized in any system or application in which identity of entities is matched to a collection of entities.

Other embodiments of the present teachings will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for identifying an entity, comprising:
receiving a request to match an entity to a collection of identified entities, the request comprising a probe identity of the entity;
determining a phonetic code for a probe name part of the probe identity;
identifying phonetic groups from a plurality of phonetic groups based on the phonetic code, wherein each phonetic group of the plurality of phonetic groups is associated with a determined phonetic code and wherein a name part of identities of the identified entities;
retrieving identities associated with the identified phonetic groups, wherein the name part of each retrieved identity matches at least one determined phonetic code of identified phonetic groups;
generating a candidate list including the retrieved identities; and
providing the candidate list to a originator of the request.

2. The method of claim 1, further comprising:
determining a group order for each identified phonetic group, wherein the group order of each identified phonetic group comprises a first number of character edits to transform the phonetic code of the name part into the determined phonetic code of the identified phonetic group;
determining a name part edit score for each name part associated the identified phonetic group, wherein the name part edit score for each name part comprises a second number of character edits to transform the probe name part into the name part associated with the identified phonetic group; and
determining an overall part score for each name part, wherein the overall part score comprises a mathematical combination of the name part edit score of the name part of the identified group and the group order of the identified phonetic group associated with the name part.

3. The method of claim 2, wherein generating the candidate list comprises including each overall part score for each retrieved identity.

4. The method of claim 2, wherein the mathematical combination is arithmetic addition.

5. The method of claim 2, wherein generating the candidate list comprises including retrieved identities with the name part edit score equal to or less than a maximum name part edit score.

6. The method of claim 5, wherein the request comprises the maximum name part edit score.

7. The method of claim 2, wherein retrieving identities associated with the identified phonetic groups comprises retrieving identities associated with identified phonetic groups with the group order less than or equal to a maximum group order.

8. The method of claim 7, wherein the request comprises the maximum group order.

9. The method of claim 2, further comprising:
determining a second phonetic code for a second probe name part of the probe identity;
identifying second phonetic groups from the plurality of phonetic groups based on the second phonetic code; and
retrieving second identities associated with the second identified phonetic groups, wherein a name part of each second retrieved identity matches at least one determined phonetic code of identified second phonetic groups;
wherein generating the candidate list comprises including the retrieved second identities.

10. The method of claim 9, further comprising:
determining a group order for each identified second phonetic group, wherein the group order of each identified second phonetic group comprises a third number of character edits to transform the second phonetic code of the second probe name part into the determined phonetic code of the identified phonetic group;
determining a name part edit score for each name part associated the identified second phonetic group, wherein the name part edit score for each name part comprises a second number of character edits to transform the second probe name part into the name part associated with the identified second phonetic group; and
determining an overall part score for each name part, wherein the overall part score comprises a mathematical combination of the name part edit score of the name part of the second identified group and the group order of the identified second phonetic group associated with the name part.

11. The method of claim 10, further comprising:
determining an overall identity score, wherein the overall identity score comprise a mathematical combination of the overall part score for the retrieved identity and the overall part score for the second retrieved identity, wherein generating the candidate list comprises including the overall identity score.

12. The method of claim 1, wherein the phonetic code is a double metaphone phonetic code.

13. The method of claim 1, wherein the request further comprises a selection of collections to perform matching.

14. The method of claim 1, wherein providing the candidate list comprises generating an interface to display the candidate list.

15. A computer readable medium comprising instructions for causing a computer to perform a method for identifying an entity, the method comprising:
receiving a request to match an entity to a collection of identified entities, the request comprising a probe identity of the entity;
determining a phonetic code for a probe name part of the probe identity;
identifying phonetic groups from a plurality of phonetic groups based on the phonetic code, wherein each phonetic group of the plurality of phonetic groups is associated with a determined phonetic code and wherein a name part of identities of the identified entities;
retrieving identities associated with the identified phonetic groups, wherein the name part of each retrieved identity matches at least one determined phonetic code of identified phonetic groups;
generating a candidate list including the retrieved identities; and
providing the candidate list to a originator of the request.

16. The computer readable medium of claim 15, the method further comprising:
determining a group order for each identified phonetic group, wherein the group order of each identified phonetic group comprises a first number of character edits to transform the phonetic code of the name part into the determined phonetic code of the identified phonetic group;
determining a name part edit score for each name part associated the identified phonetic group, wherein the name part edit score for each name part comprises a second number of character edits to transform the probe name part into the name part associated with the identified phonetic group; and
determining an overall part score for each name part, wherein the overall part score comprises a mathematical combination of the name part edit score of the name part of the identified group and the group order of the identified phonetic group associated with the name part.

17. The computer readable medium of claim 16, wherein generating the candidate list comprises including each overall part score for each retrieved identity.

18. The computer readable medium of claim 16, wherein generating the candidate list comprises including retrieved identities with the name part edit score equal to or less than a maximum name part edit score.

19. The computer readable medium of claim 16, wherein retrieving identities associated with the identified phonetic groups comprises retrieving identities associated with identified phonetic groups with the group order less than or equal to a maximum group order.

20. The computer readable medium of claim 16, determining a second phonetic code for a second probe name part of the probe identity;
identifying second phonetic groups from the plurality of phonetic groups based on the second phonetic code; and
retrieving second identities associated with the second identified phonetic groups, wherein a name part of each second retrieved identity matches at least one determined phonetic code of identified second phonetic groups;
wherein generating the candidate list comprises including the retrieved second identities.

21. The computer readable medium of claim 20, the method further comprising:
determining a group order for each identified second phonetic group, wherein the group order of each identified second phonetic group comprises a third number of character edits to transform the second phonetic code of the second probe name part into the determined phonetic code of the identified phonetic group;
determining a name part edit score for each name part associated the identified second phonetic group, wherein the name part edit score for each name part comprises a second number of character edits to transform the second probe name part into the name part associated with the identified second phonetic group; and
determining an overall part score for each name part, wherein the overall part score comprises a mathematical combination of the name part edit score of the name part of the second identified group and the group order of the identified second phonetic group associated with the name part.

22. The computer readable medium of claim 21, the method further comprising:
determining an overall identity score, wherein the overall identity score comprise a mathematical combination of the overall part score for the retrieved identity and the overall part score for the second retrieved identity, wherein generating the candidate list comprises including the overall identity score.

23. An system for identifying an entity, comprising:
a matching module configured to match an probe identity of the entity, the matching module comprising:
a matching engine configured to determine a phonetic code for a probe name part of the probe identity; to identify phonetic groups from a plurality of phonetic groups based on the phonetic code, wherein each phonetic group of the plurality of phonetic groups is associated with a determined phonetic code and wherein a name part of identities of the identified entities; to retrieve identities associated with the identified phonetic groups, wherein the name part of each retrieved identity matches at least one determined phonetic code of identified phonetic groups; and to generate a candidate list including the retrieved identities; and
an application interface configured to provide interfaces for receiving a request with the probe identity and for providing the candidate list to an originator of the request.
